(19) United States
(12) Patent Application Publication
(10) Pub. No.: US 2025/0065277 A1
(43) Pub. Date: Feb. 27, 2025

(54) POLYAMIDE COMPOSITE MEMBRANE PREPARED BY VAPOR-ASSISTED ELECTROSTATIC SPRAY, PREPARATION METHOD AND APPLICATION THEREOF

(71) Applicant: NINGBO INSTITUTE OF MATERIALS TECHNOLOGY AND ENGINEERING, CHINESE ACADEMY OF SCIENCES, Ningbo, Zhejiang (CN)

(72) Inventors: Jianqiang WANG, Ningbo, Zhejiang (CN); Fu LIU, Ningbo, Zhejiang (CN); Weilin ZHANG, Ningbo, Zhejiang (CN); Haibo LIN, Ningbo, Zhejiang (CN)

(21) Appl. No.: 18/561,680

(22) PCT Filed: May 13, 2022
(86) PCT No.: PCT/CN2022/092701

§ 371 Date: Jun. 11, 2024

(30) Foreign Application Priority Data
Jul. 15, 2021 (CN) 202110798696.7

(51) Int. Cl. B01D 69/12; B01D 61/02; B01D 67/00; B01D 71/56; C02F 1/44; C02F 103/08

(52) U.S. Cl. CPC B01D 69/1251; B01D 67/0006; B01D 71/56; C02F 1/441; C02F 1/442; B01D 61/025; B01D 61/027; B01D 2323/12; B01D 2323/26; B01D 2323/40; B01D 2323/42; B01D 2325/04; B01D 2325/20; C02F 2103/08

(57) ABSTRACT

A method of preparing a polyamide composite membrane using a vapor-assisted electrostatic spray is provided which relates to the field of preparation of polyamide composite membranes and comprises: step S1, adjusting a relative humidity of a surrounding environment of an electrostatic spray equipment to 80% to 90%; step S2, taking an amine monomer solution and an acyl chloride monomer solution as raw materials and placing the two raw materials in a spray system of the electrostatic spray equipment; step S3, wrapping a polymer ultrafiltration membrane on a receiving roller of the electrostatic spray equipment and setting electrostatic spray process parameters for electrostatic spraying; step S4, taking down an electrostatically-sprayed composite polymer membrane and placing the composite polymer membrane in an environment of 50 to 80° C. for heat treatment of 5 to 20 minutes, to prepare a finished polyamide composite membrane.

### TECHNICAL FIELD

The present disclosure relates to the field of preparation of polyamide composite membranes, and in particular to a polyamide composite membrane prepared by vapor-assisted electrostatic spray, a preparation method and an application thereof.

### BACKGROUND

Nano-filtration and reverse osmosis technology has been widely applied in multiple water treatment processes. At present, the commercial nano-filtration membranes dominating the market are mainly prepared by interfacial polymerization. The nano-filtration and reverse osmosis membranes are widely applied in the fields such as industrial wastewater treatment and desalination, pure water production, and sea water desalination and the like. Currently, multiple strategies have been developed to improve membrane permeation flux. But, seen from the entire membrane separation process, pure permeation flux improvement makes limited contribution to the improvement of the efficiency of the membrane separation system and the reduction of the system energy consumption. Therefore, for the nano-filtration and reverse osmosis separation technology, improving the selective separation performance of the membranes while ensuring the membrane permeation flux will become an upcoming development topic. The improvement of the selective separation performance can not only enable the function of the membrane separation technology to be fully reflected in the entire water treatment process but also significantly expand the application scope of the membrane separation technology. The membrane selectivity is mainly reflected in its selectivity for water and solute. At present, most of the nano-filtration membranes can satisfy the former (selectivity for water and solute) requirements (the interception rate for some high-valent salt ions and organic substances is as high as 98%). But the selective separation for solutes with similar sizes (including salt ions and organic substances) still faces a huge challenge.

The selective separation performance between molecules or ions of the solutes with similar sizes is mainly determined by the pore size uniformity of the polyamide separation layer. In a classical interfacial polymerization process, due to the influence of wide pore size distribution of the ultrafiltration base membrane, and the uncontrollability of monomer diffusion rate and interfacial polymerization reaction rate and the like, the current commercial polyamide composite membrane has a wide pore size distribution, unable to realize high-selectivity separation between solutes. In order to remove the influence of the ultrafiltration base membrane on the interfacial polymerization, Santanu Karan et al. adopted Cd(OH)3 nanowire with a diameter of 1-2 nm as an intermediate layer (Science, 2015, 348, 1347), so as to effectively realize controlled release of the amine monomer. Although this method can effectively reduce the defects of the polyamide layer and obtain an ultrathin (less than 10 nm) polyamide separation layer, its selective separation performance is still unsatisfactory. In 2018, Zhe Tan et al. adopted the strategy of increasing the viscosity of the aqueous reaction solution to effectively control the diffusion rate of the aqueous monomer (Science, 2018, 360, 518). Maqsud R. Chowdhury et al. adopted the 3D printing strategy (Science, 2018, 361, 682: US patent application number: US20190030493A1) to perform effective diffusion on oily and aqueous reaction solutions so as to obtain an ultrathin polyamide separation layer with a low surface roughness. Although the above strategy controls the monomer diffusion rate to some degree and counteracts the influence of the ultrafiltration base membrane, the prepared membrane does not satisfy the requirements of the selectivity between molecules/ions of the solutes. In 2020, Yuanzhe Liang et al. adopted a surfactant-assisted interfacial polymerization method to successfully prepare a polyamide separation layer of narrow subnano pore size distribution, which has a separation accuracy of as high as 1 Å between solutes (Nature Communication, 2020, 11, 2015). This method has strict requirements for the operation of the interfacial polymerization process, which is unfavorable for scale production. Further, preparation of polyamide nanofiltration membrane by classical interfacial polymerization method has the problem of producing a large amount of oily and aqueous waste liquids and low utilization rate of reaction monomers and the like.

### SUMMARY

For the problem of wide pore size distribution of the separation layer of the polyamide composite membrane in the prior arts, the present disclosure provides a method of preparing a polyamide composite membrane using vapor-assisted electrostatic spray, in which a polyamide composite membrane with narrow pore size distribution can be prepared by a vapor-assisted electrostatic spray interfacial polymerization method.

The technical scheme employed in the examples of the present disclosure is to provide a method of preparing a polyamide composite membrane using a vapor-assisted electrostatic spray, which includes the following steps:
at step S1, adjusting a relative humidity of a surrounding environment of an electrostatic spray equipment to 80% to 90%;
at step S2, taking an amine monomer solution and an acyl chloride monomer solution as raw materials and placing the two raw materials in a spray system of the electrostatic spray equipment;
at step S3, wrapping a polymer ultrafiltration membrane on a receiving roller of the electrostatic spray equipment and setting electrostatic spray process parameters for electrostatic spraying;
at step S4, taking down an electrostatically-sprayed composite polymer membrane and placing the composite polymer membrane in an environment of 50 to 80° C. for heat treatment of 5 to 20 minutes, to prepare a finished polyamide composite membrane.

The preparation of the polyamide separation layer with narrow pore size distribution is achieved by the following control technology in the present disclosure.

1) In an environment of high relative humidity, a partial pressure of water vapor is large, leading to a smaller difference with a saturated vapor pressure. Therefore, in the electrostatic spray interfacial polymerization process, the volatilization rate of water in the aqueous liquid droplets is lower and the contact area of the liquid droplets on the ultrafiltration base membrane is larger, and hence, the dispersibility of the amine monomer in the aqueous phase on the ultrafiltration base membrane can be improved.

2) Due to the improved dispersibility of the amine monomer, the reaction degree (crosslinking degree) between the amine monomer and the acyl chloride monomer is increased, which narrows the pore size distribution o of the obtained polyamide separation layer.

Based on the technically innovative theoretical method of the present disclosure, the prepared polyamide composite membrane has effectively-improved selective separation performance, and the prepared polyamide composite membrane has significantly improved selective separation effect on monovalent/multivalent ions and the molecules of organic substances of similar sizes, which is expected to increase the salt separation and anti-fouling performance of the nanofiltration and reverse osmosis membrane in wastewater zero emission process. Furthermore, the improvement of the selective separation performance of the polyamide composite membrane by the technology of the present disclosure is expected to further expand its application in separation and purification of pharmaceutical molecules, chiral molecular separation, and separation of micro-molecules such as antibiotics and endocrine disruptors.

In some examples, the relative humidity is adjusted by using a blended solution of water and alcohol in the step S1. The ratio of alcohol in the blended solution is 5% to 20%. Compared with adjustment with pure water, the adjustment to the relative humidity by using the blended solution of water and alcohol can further improve the selective separation performance of the membrane. The applicant finds that the addition of an alcohol substance helps fast atomization and dispersion of water. In this way, the relative humidity of the spraying environment can be accurately controlled in a short time, facilitating scaling-up of the technology. Furthermore, since the low surface energy of the alcohol solvent is lower than that of water, the size of the water droplets will be smaller during the humidification process. Less impact will be brought to the aqueous liquid droplets and oily liquid droplets containing reaction monomers for electrostatic spray, helping increase the stability and reliability of the polyamide nanofiltration membrane prepared using electrostatic spray technology.

In some examples, the alcohol in the blended solution is one or more of ethanol, isopropanol and n-butyl alcohol.

In some examples, the concentration of the amine monomer solution in the step S2 is 0.05 wt % to 2.0 wt %; the amine monomer is one or more of piperazine, m-phenylenediamine, o-phenylenediamine, and p-phenylenediamine; a solvent of the amine monomer solution is water.

In some examples, the concentration of the acyl chloride monomer solution in the step S2 is 0.01 wt % to 1.0 wt %; the acyl chloride monomer is trimesoyl chloride; a solvent of the acyl chloride monomer solution is one or more of n-hexane, cyclohexane, n-heptane, methylbenzene, xylene and acetone.

In some examples, the electrostatic spray process parameters in step S3 include a spray head diameter 0.2 to 1.0 mm, an electrostatic spray advance speed 0.2 to 5.0 mL/h, an applied voltage of the electrostatic spray 5 to 20 kV, a spray distance 5 to 20 cm, a rotation speed of the receiving roller 20 to 500 rpm, an ambient temperature of the electrostatic spray 20 to 60° C. and an electrostatic spray time 0.5 to 20 h.

In some examples, the polymer ultrafiltration membrane in step S3 is a polysulfone ultrafiltration membrane, a polyether sulfone ultrafiltration membrane, a polyphenylsulfone ultrafiltration membrane, a polyacrylonitrile ultrafiltration membrane, a polyvinylidene fluoride ultrafiltration membrane, a polystyrene ultrafiltration membrane, or a polyvinyl chloride ultrafiltration membrane.

In some examples, a thin membrane structure prepared by any one of the above methods is included.

In some examples, the thin membrane structure includes a separation layer with a thickness of 10 to 500 nm. Under a crossflow condition and an external pressure of 5 to 10 bar, the polyamide composite membrane has a selectivity of 40 or more for NaCl and Na₂SO₄.

The present disclosure has the following beneficial technical effects.

When the polyamide composite membrane is prepared using the technical method of the present disclosure, there is no need for a huge amount of aqueous and organic solvents, and the reaction monomer utilization rate is higher, more easily achieving scale production. The membrane prepared by using the technical method of the present disclosure has the characteristics of controlled separation layer thickness (10-500 nm), low surface roughness, narrow pore size distribution and highly-selective separation. The vapor source used in the method of the present disclosure is a mixture of water and alcohol, which is green and non-toxic. The polyamide composite nanofiltration membrane (20-30 Lm⁻²h⁻¹bar⁻¹) and reverse osmosis membrane (2-3 Lm⁻²h⁻¹bar⁻¹) prepared by using the technology of the present disclosure has high pure water permeation flux. The prepared polyamide separation layer has the characteristics of narrow pore size distribution, which can significantly increase the selectivity of the nanofiltration membrane for monovalent/divalent ions and the separation selectivity for neutral organic molecules of similar molecular sizes.

### BRIEF DESCRIPTIONS OF THE DRAWINGS

FIG. 1 is a section electron microscope (SEM) photo of an ultrafiltration membrane used in example 1 of the present disclosure.

FIG. 2 is a section electron microscope (SEM) photo of a polyamide composite nanofiltration membrane prepared in example 1 of the present disclosure.

### DETAILED DESCRIPTIONS OF EMBODIMENTS

Several preferred examples of the present disclosure will be described by referring to the drawings of the present disclosure to enable its technical contents to be clearer and more intelligible. The present disclosure can be embodied by different forms of examples and the protection scope of the present disclosure is not limited to the examples mentioned in the present disclosure.

In the present disclosure, a selectivity for NaCl and Na₂SO₄ is calculated by using an interception rate (R) of a membrane for NaCl and Na₂SO₄(1−R_{NaCl})/(1−R_{Na2SO4}).

In the present disclosure, the pore size distribution specifically refers to that, under a crossflow condition and an external pressure of 5 to 10 bar, the polyamide composite membrane has a selectivity of 40 or more for NaCl and Na₂SO₄.

In the present disclosure, in a environment of high humidity, a vapor-assisted electrostatic spray interfacial polymerization method is employed to solve the problem of wide pore size distribution of the polyamide composite membrane in the prior arts and inability to achieve highly selective separation between solutes. The polyamide composite membrane prepared in the present disclosure has a narrow pore size distribution, and thus has significantly-improved selective separation effect on monovalent/multivalent ions and molecules of organic substances of similar sizes.

A method of preparing a polyamide composite membrane using vapor-assisted electrostatic spray provided in the present disclosure includes the following steps.

At step S1, a relative humidity of a surrounding environment of an electrostatic spray equipment is adjusted to 80% to 90%.

At step S2, an amine monomer solution and an acyl chloride monomer solution are taken as raw materials and the two raw materials are placed in a spray system of the electrostatic spray equipment.

At step S3, a polymer ultrafiltration membrane is wrapped on a receiving roller of the electrostatic spray equipment and electrostatic spray process parameters are set for electrostatic spraying.

At step S4, an electrostatically-sprayed composite polymer membrane is taken down and the composite polymer membrane is placed in an environment of 50 to 80° C. for heat treatment of 5 to 20 minutes to prepare a finished polyamide composite membrane.

Specifically, the relative humidity is adjusted by using a blended solution of water and alcohol in the step S1. The ratio of alcohol in the blended solution is 5% to 20%. The alcohol in the blended solution is one or more of ethanol, isopropanol and n-butyl alcohol.

Specifically, the concentration of the amine monomer solution in the step S2 is 0.05 wt % to 2.0 wt %; the amine monomer is one or more of piperazine, m-phenylenediamine, o-phenylenediamine, and p-phenylenediamine; a solvent of the amine monomer solution is water.

Specifically, the concentration of the acyl chloride monomer solution in the step S2 is 0.01 wt % to 1.0 wt %; the acyl chloride monomer is trimesoyl chloride; a solvent of the acyl chloride monomer solution is one or more of n-hexane, cyclohexane, n-heptane, methylbenzene, xylene and acetone.

Specifically, the electrostatic spray process parameters in step S3 include a spray head diameter 0.2 to 1.0 mm, an electrostatic spray advance speed 0.2 to 5.0 mL/h, an applied voltage of the electrostatic spray 5 to 20 kV, a spray distance 5 to 20 cm, a rotation speed of the receiving roller 20 to 500 rpm, an ambient temperature of the electrostatic spray 20 to 60° C. and an electrostatic spray time 0.5 to 20 h.

Specifically, the polymer ultrafiltration membrane in step S3 is a polysulfone ultrafiltration membrane, a polyether sulfone ultrafiltration membrane, a polyphenylsulfone ultrafiltration membrane, a polyacrylonitrile ultrafiltration membrane, a polyvinylidene fluoride ultrafiltration membrane, a polystyrene ultrafiltration membrane, or a polyvinyl chloride ultrafiltration membrane.

A polyamide composite membrane can be prepared by using the above method of preparing a polyamide composite membrane using vapor-assisted electrostatic spray.

Specifically, the polyamide composite membrane has a separation layer with a thickness of 10 to 500 nm. Under a crossflow condition and an external pressure of 5 to 10 bar, the polyamide composite membrane has a selectivity of 40 or more for NaCl and Na₂SO₄.

Based on the technical innovation of the present disclosure, the pore size distribution of the separation layer is adjusted in an electrostatic spray interfacial polymerization process, with assistance of vapor with a high humidity of 80% to 90%. At present, nano-fiber membranes or compact separation layers are almost all prepared by electrostatic spray or electrostatic spinning with a relative humidity lower than 40%. In a low humidity environment, the solvent in an aqueous solution volatilizes faster in high electric field and the monomers in the aqueous phase are locally accumulated at the reception side, leading to inability to achieve uniform dispersion of the reaction monomers. This is one of major causes for wide pore size distribution and low selective separation performance of the polyamide separation layer currently prepared by electrostatic spray. In a high humidity environment, because the difference between the partial pressure of the water vapor and its saturated vapor pressure is smaller, the volatilization rate of the solvent in the aqueous liquid droplets is lower, which improves the size of the aqueous droplets upon arrival at the reception side, effectively guaranteeing uniform dispersion of the reaction monomers at the reception side. In addition, although higher relative humidity helps increase the uniform dispersion of the reaction monomers, the air is liable to breakthrough discharge under the action of high electric field in a case of the relative humidity higher than 90%. Therefore, in the present disclosure, the relative humidity is preferably controlled to 80% to 90%.

The amine monomer concentration used in the present disclosure is 0.05 wt % to 2.0 wt %, and the acyl chloride monomer concentration is 0.01 wt % to 1.0 wt %. In a conventional interfacial polymerization process, the amine monomer concentration usually is 0.5 wt % to 3.0 wt % and the acyl chloride monomer concentration is 0.1 wt % to 1.0 wt %. In an electrostatic spray interfacial polymerization process, most of the oily and aqueous solvents are volatilized in the spray process, and the reaction monomer concentration is several times a solution start concentration upon actual spray on a support membrane surface. Therefore, in an electrostatic spray interfacial polymerization process, the start concentrations of the aqueous and oily solutions can be lower. In the present disclosure, the amine monomer concentration is preferably 0.1 wt % to 1.0 wt %, and the acyl chloride monomer concentration is preferably 0.02 wt % to 0.5 wt %.

In the present disclosure, in order to reduce the difference between the partial pressure of the water vapor and its saturated vapor pressure in a spray process, a mixture of pure water and alcohol is used to increase the relative humidity of the spray process. The ratio of alcohol in the mixture of water and alcohol is 5% to 20%. The addition of alcohol solvent can reduce the surface tension of the solution and thus, the relative humidity can be quickly improved in a short time, helping scale application of the technology. Since the alcohol solvent is an inflammable substance, the ratio of the alcohol solvent can be controlled to below 20%. Further, alcohol substances of low concentration will not generate noticeable effect. Preferably, the ratio of water and alcohol is 5% to 10%.

A polyamide composite membrane is applied to perform industrial wastewater treatment and desalination, pure water production or sea water desalination.

In order to better understand the above technical solution, the above technical scheme will be detailed in combination with the drawings and specific examples.

### Example 1

This example provides a method of preparing a polyamide composite membrane using vapor-assisted electrostatic spray, which includes the following steps.

At step S1, a polyether sulfone ultrafiltration membrane was fixed on the receiving roller of the electrostatic spray equipment.

At step S2, an aqueous solution of piperazine with a concentration of 0.24 wt % and a solution of trimesoyl chloride and n-hexane with a concentration of 0.08 wt % were prepared.

At step S3, the solutions obtained in step S2 were loaded into an injector which was then mounted to the electrostatic spray equipment for preparing a membrane by using electrostatic spray, where the electrostatic spray parameters included: a spray head diameter 0.7 mm, a voltage 10 kV, a reception distance 10 cm, an advance speed 1.0 mL/h, transverse movement speed of the electrostatic spray equipment 100 mm/min, a rotation speed of the receiving roller 80 rpm, an ambient temperature of the spray 30° C., an ambient humidity of the spray 80% achieved by humidifying with pure water, and a spray time 2 h.

At step S4, the spray membrane was taken down from the receiving roller and heated at the temperature of 60° C. for 10 minutes to obtain the polyamide composite nanofiltration membrane.

The separation layer of the finished nanofiltration membrane had a thickness of 20 nm. Under a crossflow condition and an external pressure of 5 bar, the selectivity for NaCl and Na₂SO₄ was 46.1, and meanwhile, the permeation flux for pure water was 25.0 Lm⁻²h⁻¹bar⁻¹.

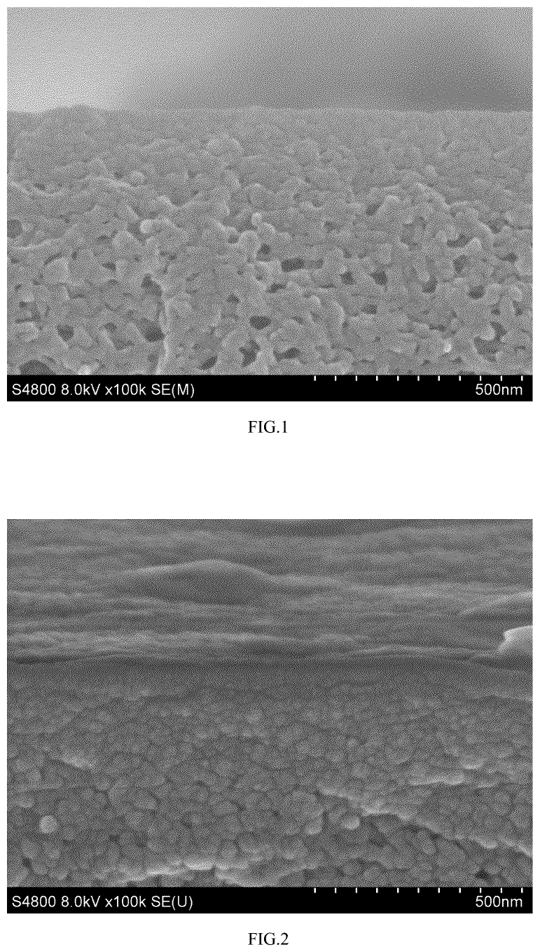

FIG. 1 is a section electron microscopy (SEM) photo of an ultrafiltration membrane used in an example of the present disclosure. Seen from FIG. 1, the section of the ultrafiltration membrane presents a gradient structure from bottom up, and the upper surface of the membrane is relatively compact but still has visible porous structure. FIG. 2 is a section electron microscopy (SEM) photo of a polyamide composite nanofiltration membrane prepared in an example of the present disclosure. Seen from FIG. 2, there is one compact polyamide layer on the upper surface of the ultrafiltration membrane. Through comparison of FIGS. 1 and 2, it can be known that a complete polyamide separation layer can be formed on the surface of the ultrafiltration membrane by using the electrostatic spray method, and the thickness of the polyamide layer prepared at the relative humidity of 80% is relatively small, with its surface presenting smooth morphology. The reduction of the thickness of the polyamide layer and the improvement of the surface uniformity can help obtain a polyamide composite membrane with high flux and high selectivity.

### Control Example 1

This control example provides a method of preparing a polyamide composite membrane, which includes the following steps.

At step S1, a polyether sulfone ultrafiltration membrane was fixed on the receiving roller of the electrostatic spray equipment.

At step S2, an aqueous solution of piperazine with a concentration of 0.24 wt % and a solution of trimesoyl chloride and n-hexane with a concentration of 0.08 wt % were prepared.

At step S3, the solutions obtained in step S2 were loaded into an injector which was then mounted to the electrostatic spray equipment for preparing a membrane by using electrostatic spray, where the electrostatic spray parameters included: a spray head diameter 0.7 mm, a voltage 10 kV, a reception distance 10 cm, an advance speed 1.0 mL/h, transverse movement speed of the electrostatic spray equipment 100 mm/min, a rotation speed of the receiving roller 80 rpm, an ambient temperature of the spray 30° C., an ambient humidity of the spray 60% achieved by humidifying with pure water, and a spray time 2 h.

At step S4, the spray membrane was taken down from the receiving roller and heated at the temperature of 80° C. for 5 minutes to obtain the polyamide composite nanofiltration membrane.

The separation layer of the finished nanofiltration membrane had a thickness of 20 nm. Under a crossflow condition and an external pressure of 5 bar, the selectivity for NaCl and Na₂SO₄ was 35.3, and meanwhile, the permeation flux for pure water was 23.1 Lm⁻²h⁻¹bar⁻¹.

### Example 2

This example provides a method of preparing a polyamide composite membrane using vapor-assisted electrostatic spray, which includes the following steps.

At step S1, a polyether sulfone ultrafiltration membrane was fixed on the receiving roller of the electrostatic spray equipment.

At step S2, an aqueous solution of piperazine with a concentration of 0.24 wt % and a solution of trimesoyl chloride and n-hexane with a concentration of 0.08 wt % were prepared.

At step S3, the solutions obtained in step S2 were loaded into an injector which was then mounted to the electrostatic spray equipment for preparing a membrane by using electrostatic spray, where the electrostatic spray parameters included: a spray head diameter 0.7 mm, a voltage 10 kV, a reception distance 10 cm, an advance speed 1.0 mL/h, transverse movement speed of the electrostatic spray equipment 100 mm/min, a rotation speed of the receiving roller 80 rpm, an ambient temperature of the spray 30° C., an ambient humidity of the spray 90% achieved by humidifying with pure water, and a spray time 2 h.

At step S4, the spray membrane was taken down from the receiving roller and heated at the temperature of 60° C. for 10 minutes to obtain the polyamide composite nanofiltration membrane.

The separation layer of the finished nanofiltration membrane had a thickness of 20 nm. Under a crossflow condition and an external pressure of 5 bar, the selectivity for NaCl and Na₂SO₄ was 50.1, and meanwhile, the permeation flux for pure water was 29.0 Lm⁻²h⁻¹bar⁻¹.

### Example 3

This example provides a method of preparing a polyamide composite membrane using vapor-assisted electrostatic spray, which includes the following steps.

At step S1, a polyether sulfone ultrafiltration membrane was fixed on the receiving roller of the electrostatic spray equipment.

At step S2, an aqueous solution of piperazine with a concentration of 0.24 wt % and a solution of trimesoyl chloride and n-hexane with a concentration of 0.08 wt % were prepared.

At step S3, the solutions obtained in step S2 were loaded into an injector which was then mounted to the electrostatic spray equipment for preparing a membrane by using electrostatic spray, where the electrostatic spray parameters included: a spray head diameter 0.7 mm, a voltage 10 kV, a reception distance 10 cm, an advance speed 1.0 mL/h, transverse movement speed of the electrostatic spray equipment 100 mm/min, a rotation speed of the receiving roller 80 rpm, an ambient temperature of the spray 30° C., an ambient humidity of the spray 90% achieved by humidifying with 10% aqueous solution of ethanol, and a spray time 2 h.

At step S4, the spray membrane was taken down from the receiving roller and heated at the temperature of 60° C. for 10 minutes to obtain the polyamide composite nanofiltration membrane.

The separation layer of the finished nanofiltration membrane had a thickness of 20 nm. Under a crossflow condition and an external pressure of 5 bar, the selectivity for NaCl and Na₂SO₄ was 55.1, and meanwhile, the permeation flux for pure water was 28.5 Lm⁻²h⁻¹bar⁻¹.

### Example 4

This example provides a method of preparing a polyamide composite membrane using vapor-assisted electrostatic spray, which includes the following steps.

At step S1, a polyvinylidene fluoride ultrafiltration membrane was fixed on the receiving roller of the electrostatic spray equipment.

At step S2, an aqueous solution of m-phenylenediamine with a concentration of 2.0 wt % and a solution of trimesoyl chloride and n-hexane with a concentration of 0.6 wt % were prepared.

At step S3, the solutions obtained in step S2 were loaded into an injector which was then mounted to the electrostatic spray equipment for preparing a membrane by using electrostatic spray, where the electrostatic spray parameters included: a spray head diameter 0.7 mm, a voltage 10 kV, a reception distance 10 cm, an advance speed 1.0 mL/h, transverse movement speed of the electrostatic spray equipment 100 mm/min, a rotation speed of the receiving roller 80 rpm, an ambient temperature of the spray 30° C., an ambient humidity of the spray 80% achieved by humidifying with pure water, and a spray time 6 h.

At step S4, the spray membrane was taken down from the receiving roller and heated at the temperature of 60° C. for 10 minutes to obtain the polyamide reverse osmosis composite membrane.

The separation layer of the finished reverse osmosis membrane had a thickness of 100 nm. Under a crossflow condition and an external pressure of 10 bar, the selectivity for NaCl and Na₂SO₄ was 40.5, and meanwhile, the permeation flux for pure water was 2.5 Lm⁻²h⁻¹bar⁻¹.

### Control Example 2

This control example provides a method of preparing a polyamide composite membrane, which includes the following steps.
At step S1, a polyvinylidene fluoride ultrafiltration membrane was fixed on the receiving roller of the electrostatic spray equipment.
At step S2, an aqueous solution of m-phenylenediamine with a concentration of 2.0 wt % and a solution of trimesoyl chloride and n-hexane with a concentration of 0.6 wt % were prepared.
At step S3, the solutions obtained in step S2 were loaded into an injector which was then mounted to the electrostatic spray equipment for preparing a membrane by using electrostatic spray, where the electrostatic spray parameters included: a spray head diameter 0.7 mm, a voltage 10 kV, a reception distance 10 cm, an advance speed 1.0 mL/h, transverse movement speed of the electrostatic spray equipment 100 mm/min, a rotation speed of the receiving roller 80 rpm, an ambient temperature of the spray 30° C., an ambient humidity of the spray 30% achieved by humidifying with pure water, and a spray time 6 h.
At step S4, the spray membrane was taken down from the receiving roller and heated at the temperature of 60° C. for 10 minutes to obtain the polyamide reverse osmosis composite membrane.

The separation layer of the finished reverse osmosis membrane had a thickness of 100 nm. Under a crossflow condition and an external pressure of 10 bar, the selectivity for NaCl and Na₂SO₄ was 5.0, and meanwhile, the permeation flux for pure water was 1.8 Lm⁻²h⁻¹bar⁻¹.

### Example 5

This example provides a method of preparing a polyamide composite membrane using vapor-assisted electrostatic spray, which includes the following steps.
At step S1, a polyvinylidene fluoride ultrafiltration membrane was fixed on the receiving roller of the electrostatic spray equipment.
At step S2, an aqueous solution of m-phenylenediamine with a concentration of 2.0 wt % and a solution of trimesoyl chloride and n-hexane with a concentration of 0.6 wt % were prepared.
At step S3, the solutions obtained in step S2 were loaded into an injector which was then mounted to the electrostatic spray equipment for preparing a membrane by using electrostatic spray, where the electrostatic spray parameters included: a spray head diameter 0.7 mm, a voltage 10 kV, a reception distance 10 cm, an advance speed 1.0 mL/h, transverse movement speed of the electrostatic spray equipment 100 mm/min, a rotation speed of the receiving roller 80 rpm, an ambient temperature of the spray 30° C., an ambient humidity of the spray 80% achieved by humidifying with 10% aqueous solution of ethanol, and a spray time 6 h.
At step S4, the spray membrane was taken down from the receiving roller and heated at the temperature of 60° C. for 10 minutes to obtain the polyamide reverse osmosis composite membrane.

The separation layer of the finished reverse osmosis membrane had a thickness of 100 nm. Under a crossflow condition and an external pressure of 10 bar, the selectivity for NaCl and Na₂SO₄ was 43.5, and meanwhile, the permeation flux for pure water was 2.4 Lm⁻²h⁻¹bar⁻¹.

As mentioned above, the examples 1 to 3 are nanofiltration systems and the examples 4 to 5 are reverse osmosis systems. When the composite membrane is used as nanofiltration membrane, piperazine is used as aqueous monomer; when the composite membrane is used as reverse osmosis membrane, m-phenylenediamine is used as aqueous monomer. The thickness of the reverse osmosis membrane in the examples 4 to 5 is 100 nm but this thickness can be replaced with a thickness of 100 to 500 nm.

The above descriptions are made to the preferred examples of the present disclosure but shall not be understood as limiting of the claims. The present disclosure is not limited to the above examples and may have changes to its specific structure. Various changes made within the scope of protection of the claims of the present disclosure shall fall within the scope of protection of the present disclosure.

1. A method of preparing a polyamide composite membrane using a vapor-assisted electrostatic spray, wherein the method comprises the following steps:
Step S1, adjusting a relative humidity of a surrounding environment of an electrostatic spray equipment to 80% to 90%;
Step S2, taking an amine monomer solution and an acyl chloride monomer solution as raw materials and placing the two raw materials in a spray system of the electrostatic spray equipment;
Step S3, wrapping a polymer ultrafiltration membrane on a receiving roller of the electrostatic spray equipment and setting electrostatic spray process parameters for electrostatic spraying;
Step S4, taking down an electrostatically-sprayed composite polymer membrane and placing the composite polymer membrane in an environment of 50 to 80° C. for heat treatment of 5 to 20 minutes, to prepare a finished polyamide composite membrane.

2. The method of preparing a polyamide composite membrane using a vapor-assisted electrostatic spray of claim 1, wherein the relative humidity is adjusted by using a blended solution of water and alcohol in the step S1 and the ratio of alcohol in the blended solution is 5% to 20%.

3. The method of preparing a polyamide composite membrane using a vapor-assisted electrostatic spray of claim 2, wherein the alcohol in the blended solution is one or more of ethanol, isopropanol and n-butyl alcohol.

4. The method of preparing a polyamide composite membrane using a vapor-assisted electrostatic spray of claim 1, wherein the concentration of the amine monomer solution in the step S2 is 0.05 wt % to 2.0 wt %; the amine monomer is one or more of piperazine, m-phenylenediamine, o-phenylenediamine, and p-phenylenediamine; a solvent of the amine monomer solution is water.

5. The method of preparing a polyamide composite membrane using a vapor-assisted electrostatic spray of claim 1, wherein the concentration of the acyl chloride monomer solution in the step S2 is 0.01 wt % to 1.0 wt %; the acyl chloride monomer is trimesoyl chloride; a solvent of the acyl chloride monomer solution is one or more of n-hexane, cyclohexane, n-heptane, methylbenzene, xylene and acetone.

6. The method of preparing a polyamide composite membrane using a vapor-assisted electrostatic spray of claim 1, wherein the electrostatic spray process parameters in step S3 include a spray head diameter 0.2 to 1.0 mm, an electrostatic spray advance speed 0.2 to 5.0 mL/h, an applied voltage of the electrostatic spray 5 to 20 kV, a spray distance 5 to 20 cm, a rotation speed of the receiving roller 20 to 500 rpm, an ambient temperature of the electrostatic spray 20 to 60° C. and an electrostatic spray time 0.5 to 20 h.

7. The method of preparing a polyamide composite membrane using a vapor-assisted electrostatic spray of claim 1, wherein the polymer ultrafiltration membrane in step S3 is a polysulfone ultrafiltration membrane, a polyether sulfone ultrafiltration membrane, a polyphenylsulfone ultrafiltration membrane, a polyacrylonitrile ultrafiltration membrane, a polyvinylidene fluoride ultrafiltration membrane, a polystyrene ultrafiltration membrane, or a polyvinyl chloride ultrafiltration membrane.

8. A polyamide composite membrane, wherein it comprises a thin membrane structure prepared the method of claim 1.

9. The polyamide composite membrane of claim 8, wherein the thin membrane structure comprises a separation layer with a thickness of 10 to 500 nm; under a crossflow condition and an external pressure of 5 to 10 bar, the polyamide composite membrane has a selectivity of 40 or more for NaCl and Na₂SO₄.

10. The polyamide composite membrane of claim 8, wherein it can be applied in the fields in industrial wastewater treatment and desalination, pure water production, and sea water desalination.

11. The polyamide composite membrane of claim 9, wherein it can be applied in the fields in industrial wastewater treatment and desalination, pure water production, and sea water desalination.
